(19) United States
(12) Patent Application Publication
(10) Pub. No.: US 2018/0241311 A1
(43) Pub. Date: Aug. 23, 2018

(54) METHODS AND DEVICES FOR POWER CONVERSION

(71) Applicant: S9ESTRE, LLC, Amesbury, MA (US)

(72) Inventor: Bernd SCHAFFERER, Amesbury, MA (US)

(73) Assignee: S9estre, LLC, Amesbury, MA (US)

(21) Appl. No.: 15/751,798

(22) PCT Filed: Jul. 1, 2016
(86) PCT No.: PCT/US2016/040807

§ 371 Date: Feb. 9, 2018

Related U.S. Application Data
(60) Provisional application No. 62/317,525, filed on Apr. 2, 2016.
(60) Provisional application No. 62/304,478, filed on Mar. 7, 2016.
(60) Provisional application No. 62/204,035, filed on Aug. 12, 2015.

(51) Int. Cl. H02M 3/158; H02M 1/088

(52) U.S. Cl. CPC H02M 3/1584; H02M 2001/0048; H02M 3/158; H02M 1/088

(57) ABSTRACT

Methods and devices for power conversion. High frequency electromagnetic waves traveling in coupled transmission lines and their reflective properties are used to perform the power conversion. The use of high frequency operation allows for physically small transmission lines. The high operating frequencies also allow for small filter capacitors at the outputs of the power converter and hence allowing for fast response times in load changes or fast signal changes in case of a gate driver. The transmission lines can be implemented on the printed circuit board, laminate or even on chip. In case of a step up converter the switching elements are not subjected to the higher output voltage levels of the power converter and can therefore be implemented in a lower voltage process technology. Further, embodiments with and without galvanic isolation are described and physical embodiments to reduce undesired electromagnetic emissions are disclosed.

### CROSS REFERENCE TO RELATED APPLICATIONS

This application is a National Phase entry of PCT Application No. PCT/US2016/040807, filed on Jul. 1, 2016, which claims the benefit of U.S. Provisional Patent Application Nos. 62/304,478, filed Mar. 7, 2016, 62/204,035, filed Aug. 12, 2015, and 62/317,525, filed Apr. 2, 2016, which are incorporated by reference herein.

### TECHNICAL FIELD

The present disclosure relates in general to power conversion as in DC-DC converters, AC-DC converters and DC-AC converters, gate drivers, amplitude modulation of carrier signals and digital to analog conversion.

### BACKGROUND

Many different devices are used to convert a supply voltage from one level to another. Such devices are known as DC-DC converters. Various embodiments of DC-DC power converters are discussed in U.S. Pat. No. 8,766,607 to Sander and U.S. Pat. No. 8,174,247 to Sander (the disclosures of which are incorporated by reference herein). DC-DC converters that operate at microwave frequencies are discussed in Djukic, Slavko et al., “A Planar 4.5-GHz DC-DC Power Converter”, IEEE Transactions on Microwave Theory and Techniques; August 1999; pp. 1457-1460, vol. 47, No. 8; IEEE Service Center, Piscataway, N.J. (which is hereby incorporated by reference). Power efficiency, galvanic isolation, power density, and output voltage range are key parameters for DC-DC converters. Magnetically coupled transformers and switch mode powers converter can be used to perform this task.

Gate drivers transform control signals to a form which is suitable to drive the input of a load device. Usually, the load device requires input voltages which are higher than the voltages of the control signal. Switching speed, slew rate of the drive signal, power efficiency, galvanic isolation, power density, and output voltage range are key parameters for gate drivers.

In some cases it is desired to have a galvanic isolation between the input and the output of the power converter. In case of a DC-DC converter the input DC voltage can be transformed into an AC voltage and magnetically coupled over the isolation barrier. At the output the magnetically coupled AC energy is rectified and converted back to DC voltage.

In the gate driver case, opto-couplers can be used. The input is converted into an optical signal. The optical signal is transmitted over the galvanic barrier and converted back to an electrical signal.

Magnetically coupled transformers and opto-couplers require considerable physical space, are difficult to integrate on a chip, and in the case of opto-couplers, need supply of power at the receiver.

### SUMMARY

The present invention describes power conversion based on coupled transmission lines. The transmission lines form a resonant tank circuit. A switching element will pump energy from an energy source into the tank circuit. The transmission and reflective properties of traveling waves are utilized to perform the power conversion. The coupling parameters of the transmission lines in the tank circuits will determine the amount of energy delivered to the load. The use of high frequency operation allows for physically small transmission lines. The high operating frequencies also allow for small filter capacitors at the outputs of the power converter and hence allowing for fast response times in load changes or fast signal changes in case of a gate driver. The implementation of transmission lines is cost effective. The transmission lines can be implemented on a printed circuit board (PCB), laminate, or chip. In case of a step up converter the switching elements are not subjected to the higher output voltage levels of the power converter and can therefore be implemented in a lower voltage process technology. Further, embodiments with and without galvanic isolation are described and physical embodiments to reduce undesired electromagnetic emissions are disclosed.

One embodiment of the present disclosure is a power conversion circuit that includes an electric power source, a switching element adapted to open and close based on a control signal, an output terminal (or output node), a first termination element capable of reflecting electrical energy, a second termination element, a coupled transmission line formed from a first wave propagation medium having a first terminal and a second terminal, and a second wave propagation medium having a third terminal and a fourth terminal. The power source, the switching element, the first termination element and the first wave propagation medium are arranged such that when the switching element is closed, electrical energy can flow from the power source to the first termination element through the first wave propagation medium. The second termination element is connected to the third terminal and the output terminal connected to the fourth terminal. The control signal is periodic and is timed such that the switching element is closed for a first time period that is long enough to enable one or more pulses of electrical energy to flow from the power source to the first termination element and is open for a second time period that is long enough to prevent the one or more pulses of electrical energy from passing back through the switching element, whereby a standing wave is created in the coupled transmission line.

One embodiment of the present disclosure is a method for power conversion comprising generating an electromagnetic standing wave by injecting energy in a resonant first wave propagation medium, coupling all or part of the energy flowing in the first wave propagation medium into a second wave propagation medium and generating a standing wave in the second resonant wave propagation medium, extracting out all or part of the energy in the second resonant wave propagation medium and delivering the extracted energy to a load.

### BRIEF DESCRIPTION OF THE DRAWINGS

Subject matter hereof may be more completely understood in consideration of the following detailed description of various embodiments in connection with the accompanying figures, in which:

FIG. 1a is a schematic diagram depicting a galvanically isolated power converter, according to an embodiment;

FIG. 1b is a schematic diagram depicting a galvanically isolated power converter, according to an embodiment;

FIG. 1c is a schematic diagram depicting a galvanically isolated power converter, according to an embodiment;

FIG. 2a is a timing diagram based on simulations of the circuit in FIG. 1a;

FIG. 2b is a timing diagram based on simulations of the circuit in FIG. 1b;

FIG. 3a is a schematic diagram depicting a differential galvanically isolated power converter, according to an embodiment;

FIG. 3b is a timing diagram based on simulations of the circuit in FIG. 3a

FIG. 4 is a schematic diagram depicting a galvanically isolated power converter with controller, according to an embodiment;

FIG. 5 is a side view depicting a multibit galvanically isolated power converter, according to an embodiment;

FIG. 6a is a schematic diagram depicting a physical implementation of a power converter, according to an embodiment;

FIG. 6b is a perspective view depicting a physical implementation of a power converter, according to an embodiment;

FIG. 6c is a side view depicting a portion of a physical implementation of a power converter, according to an embodiment;

FIG. 6d is a top view depicting a portion of a physical implementation of a power converter, according to an embodiment;

FIG. 6e is a top view depicting a portion of a physical implementation of a power converter, according to an embodiment;

FIG. 6f is a top view depicting a portion of a physical implementation of a power converter, according to an embodiment;

FIG. 6g is a top view depicting a portion of a physical implementation of a power converter, according to an embodiment;

FIG. 7a is a schematic diagram depicting a power converter, according to an embodiment;

FIG. 7b is a timing diagram based on simulations of the circuit in FIG. 7a;

FIG. 7c is a schematic diagram depicting a power converter, according to an embodiment;

FIG. 7d is a timing diagram based on simulations of the circuit in FIG. 7c;

FIG. 8a is a schematic diagram depicting a power converter with a rectifier, according to an embodiment;

FIG. 8b is a timing diagram based on simulations of the circuit in FIG. 8a;

FIG. 8c is a schematic diagram depicting a power converter with a rectifier and a controller, according to an embodiment;

FIG. 9a is a schematic diagram depicting a differential power converter with a rectifier, according to an embodiment;

FIG. 9b is a schematic diagram depicting a differential power converter with a rectifier and positive and negative output voltages, according to an embodiment; and

FIG. 9c is a schematic diagram depicting a power converter system, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The basic concept of the present solution is to use the properties of high frequency traveling electromagnetic waves for power conversion. The coupling properties of wave propagation media such as transmission lines and coupled transmission lines are used to control the power conversion process. The use of high frequency operation allows for physically small transmission lines. The high operating frequencies also allow for small filter capacitors at the outputs of the power converter and hence allowing for fast response times in load changes or fast signal changes in case of a gate driver. The implementation of transmission lines is cost effective. The transmission lines can be implemented on a printed circuit board (PCB), laminate, or chip. The high operating frequencies have an additional advantage when powering certain analog circuits. Ordinary switch power supplied operated in a lower frequency range and can fall in the frequency range in which the analog circuitry is operating. This can cause interference problems between the power supply and the processed signals. By operating the power converter at high frequencies the frequency range of the analog circuits and the power converter aren't overlapping and filter techniques and or bandwidth limitation of the analog circuits can be applied to minimize the interference.

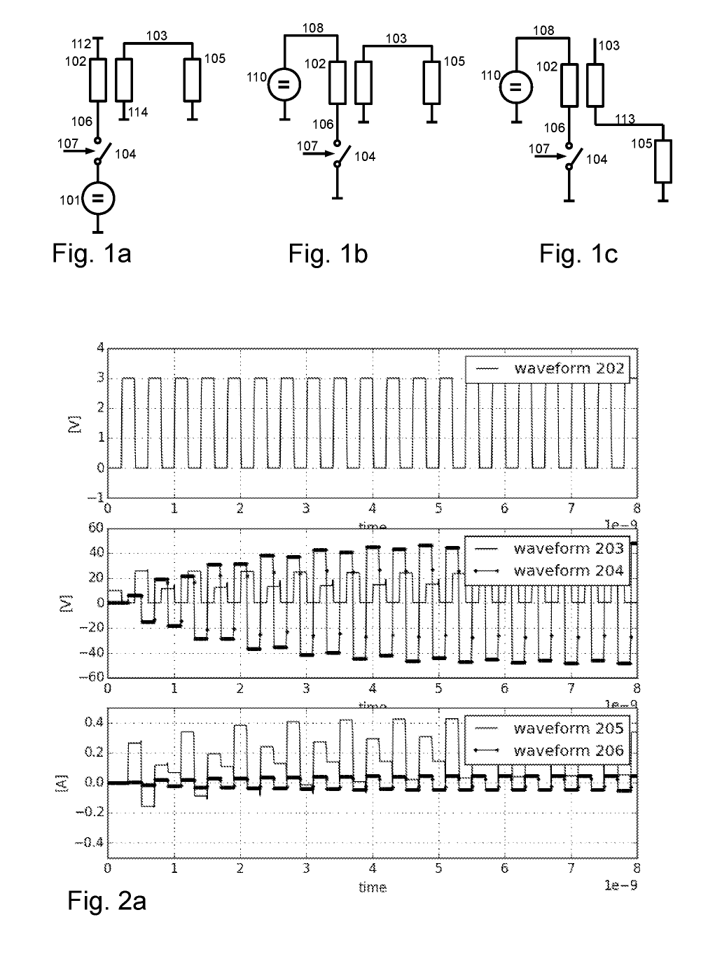

FIG. 1a; depicts an embodiment of a galvanically isolated power converter using a coupled transmission line. Power is provided to the converter by power or voltage source 101. Two sets of wave propagation media are galvanically isolated and form coupled transmission line 102. Each wave propagation medium has a first terminal and a second terminal. Power is delivered to a load 105 at an output terminal 103. The coupler operates in a resonant mode wherein the coupled transmission line 102 has an electric length of substantially one fourth of the period of the resonant frequency.

If there were no coupling between the transmission lines constituting the coupled transmission line 102, a wave introduced into the coupled transmission line 102 at node 106, by closing switch 104 would propagate towards the termination on node 112. At node 112 it would be reflected back with a reflection coefficient of −1 since node 112 is connected to ground. Before the wave returns to node 106, switch 104 is changed into a high impedance state. This would cause the wave to be reflected back towards node 112. But this time the reflection coefficient is +1, due to the high impedance termination at node 106. The wave will then be reflected at node 112 with a negative reflection coefficient of −1. At this time, the polarity of the wave arriving at node 106 has the same sign as the original wave and the switch could be closed to complete one cycle.

After a steady state solution is reached the switch 104 would only have to add an amount of energy to the transmission line which is equal to the energy lost during the two round trips of the wave.

However, since there is coupling between the transmission lines forming the coupled transmission line 102 not all of the energy injected into node 106 will reflect back to node 106 with a reflection coefficient of −1. The effective reflection coefficient of the coupled transmission line 102 will depend on the even and odd impedances of the coupled transmission lines and the impedance of the load 105. If the reflection coefficient at node 103 is not −1, the total voltage of the wave coming back to node 106, after one cycle, will be less than the voltage of the wave injected into node 106 by connecting node 106 to voltage source 101.

By closing switch 104, energy will be added to the waves traveling in the coupled transmission line 102. The energy of the wave in the transmission line will increase until the energy added to the waves, at node 106, is equivalent to the energy taken out of the waves at node 103. The power taken out at node 103 is dissipated over the load 105. The amount of energy added to the wave is determined by the voltage source 101, the even an odd mode impedances of the transmission lines and the load 105.

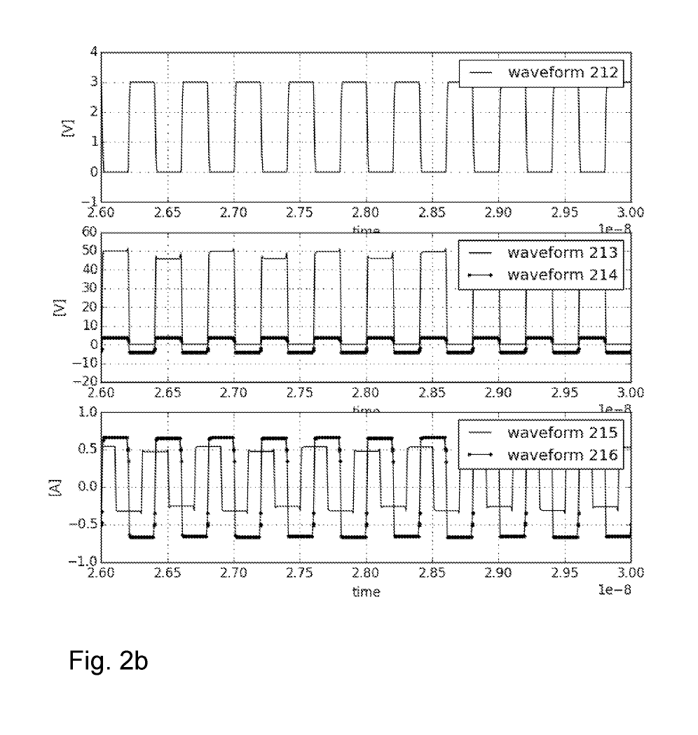

FIG. 2a depicts a simulation of the circuit of FIG. 1a during a startup. The even and odd mode impedances of coupled transmission line 102 according to this embodiment are 100 Ohm and 50 Ohm, respectively. The voltage of the voltage source is 10V and the load is 1000 Ohm. Waveform 202 is the control signal 107 of the switch 104, if the voltage of signal 107 is greater than 1.5V the switch 104 is in a low impedance state, if the voltage is lower than 1.5V the switch is in a high impedance state. Waveform 203 is the voltage at node 106, waveform 204 is the voltage at node 103. Waveform 205 is the current flowing out of the voltage source 101, and waveform 206 is the current at the load 105. The electrical length of the coupled transmission line is 100 picoseconds.

FIG. 1b depicts an embodiment of an power converter with a ground referenced switch 104. A ground referenced switch is favorable if the switch 104 is a n-type transistor and the gate drive of the switch is also ground referenced. The same holds for a p-type switch, in this case however, ground would be on the positive side of the voltage source 110. The operation of the circuit is the same as that of the circuit in FIG. 1a. Except that the circuit is powered over the coupled transmission line 102 by connecting the voltage source 110 to node 108.

With the circuits of FIG. 1a and 1b step-up converters can be designed. That is, as shown in FIGS. 2b and 2b, the voltage at node 103 can be higher than the voltages of voltage sources of 101, 110.

FIG. 1c depicts an embodiment of a step down converter. The coupled transmission line 102 has an open node at node 103. This causes an reflection coefficient of +1. The load is connected at the opposite side, node 113, of the coupled transmission line 102.

FIG. 2b depicts a simulation of the circuit of FIG. 1c. The even and odd mode impedances of coupled transmission line 102 in this embodiment are 100 Ohm and 50 Ohm, respectively. The voltage of the voltage source is 24V and the load is 1 Ohm. Waveform 212 is the control signal of switch 104. Waveform 213 is the voltage at node 106, waveform 214 is the voltage at node 113. Waveforms 215 is the current flowing out of voltage source 110, waveform 216 is the load current. The electrical length of the coupled transmission line is 100 picoseconds.

The coupled transmission lines of the circuits depicted in FIG. 1 can be implemented on a laminate or printed circuit board (PCB). For higher operating frequencies or by using slow wave transmission lines on-chip implementations are also feasible. Tuned or un-tuned coupled transmission lines can be used. Tuning the oscillation frequency can be achieved by applying tunable transmission lines like, Distributed MEMS transmission lines, lumped distributed transmission line, digitally controlled artificial dielectric (DiCad) transmission lines. The coupled transmission lines can be implemented as coaxial cable, wave guide, strip line, micro strip line or coplanar wave guide. The coupled transmission lines can be symmetrical, this is, the geometry of the first transmission lines is the same as the geometry of the second transmission line of the coupled transmission line, or the coupled transmission line can be asymmetrical.

To analyze the circuit of FIG. 1a the reflected voltages can be derived from the incident voltage by reflection matrices for the upper side, nodes 103 and 112, and the lower side, nodes 106 and 114. R1 would be the reflection matrix at nodes 112 and 103, for the incoming waves [V112+, V103+] to produce the reflected waves [V112−, V103−]. R2 is the matrix for the reflection at node 106 and 114 with the switch 104 open for the incoming waves [V106+, V114+] to calculated the reflected waves [V106+,V114+]. R3 is the matrix for the reflection at node 106 and 114 with the switch 104 closed for the incoming waves [V106+,V114+] to calculate the reflected waves [V106+,V114+]. Resistor r2 is the resistance of the load 105. Zd is the differential mode impedance of the coupled transmission line 102 between terminals 106 and 114 and terminals 112 and 103. Zc is the common mode impedance of terminals 106, 114, 112, 103 to ground.

R1=Matrix([

[−1, 0],

[−2*r2*zc/(r2*zc+r2*zd+zc*zd), (r2*zc+r2*zd−zc*zd)/(r2*zc+r2*zd+zc*zd)]])

R2=Matrix([

[1, −2*zc/(zc+zd)],

[0, −1]])

R3=Matrix([

[−1, 0],

[0, −1]])

RTOT=R3*R1*R2*R1

RTOT=Matrix([

[(4*r2*zc**2−(zc+zd)*(r2*zc+r2*zd+zc*zd))/((zc+zd)*(r2*zc+r2*zd+zc*zd)), −2*zc*(r2*zc+r2*zd−zc*zd)/((zc+zd)*(r2*zc+r2*zd+zc*zd))], [2*r2*zc*(4*r2*zc**2+(zc+zd)*(−r2*zc−r2*zd+zc*zd)−(zc+zd)*(r2*zc+r2*zd+zc*zd))/((zc+zd)*(r2*zc+r2*zd+zc*zd)**2), −(4*r2*zc**2−(zc+zd)*(r2*zc+r2*zd−zc*zd))*(r2*zc+r2*zd−zc*zd)/((zc+zd)*(r2*zc+r2*zd+zc*zd)**2)]])

RV=Matrix([[0, 0],

[−2*r2*zc/(r2*zc+r2*zd+zc*zd), 2*r2*(zc+zd)/(r2*zc+r2*zd+zc*zd)]])

VSTEADY=(Matrix([[1,0],[0,1]])−RTOT)**−1

RTOT is the matrix for one full cycle. That is, a wave is generated by a closing switch 104, the waves are then reflected back at nodes 112, 103. Then, at node 113, 114, the waves are reflected back with switch 104 closed. And finally, reflected back at nodes 112 and 103. The cycle repeats itself and every time the switch 104 is closes energy will be added to the system. This gives an infinite geometric matrix series with a steady state solution for the voltages going to node 103 given by VSTEADY. To calculate the output voltage at node 103 the incoming waves [V112+, v103+] have to be multiplied by the termination matrix RV.

This results in the first order equation for the output voltage V2 over the load r2:

V2=r2/zd*V1

with V1 being the voltage of voltage source 101. In FIG. 2a, V2 is the peak voltage of waveform 204 if time approaches infinity.

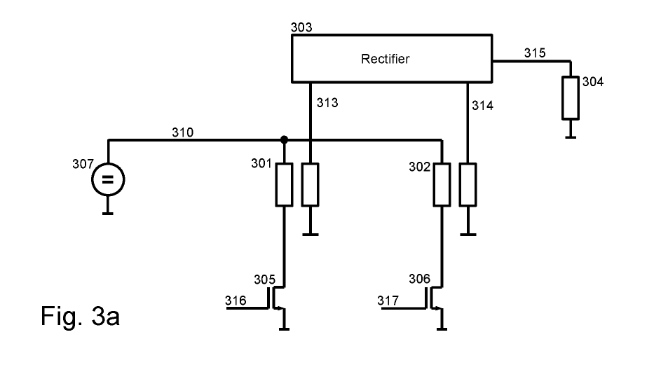

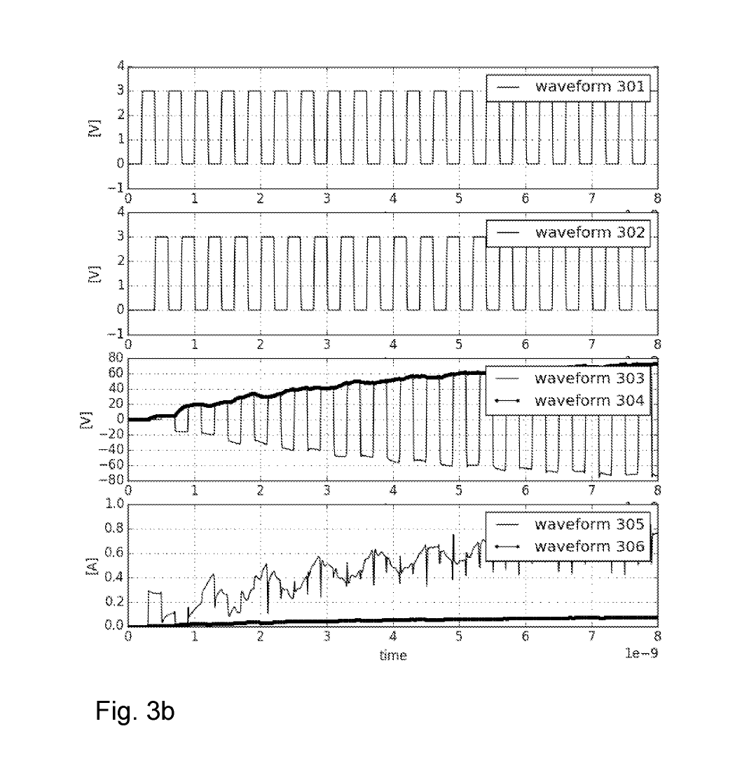

FIG. 3a depicts an embodiment of a differential power converter and FIG. 3b depicts the simulation results of the circuit in FIG. 3a. For this simulation the even and odd mode impedance of the coupled transmission lines 301 and 302 is 100 Ohm and 50 Ohm. The electrical length of the coupled transmission line is 100 picoseconds. The rectifier 303 consists of 2 diodes and the load is a 1000 Ohm resistor in parallel with a 1 pF capacitor. The transistors 305 and 306 are controlled by the complementary gate signals 316 and 317. The waveforms of the gate signals 316 and 317 are shown as waveform 301 and 302. In the circuit of FIG. 1b the current in voltage source 110 has a large AC component. This large AC component is avoided in the circuit of FIG. 3a. The coupled transmission line transformer 301 and 302 charge and discharge the voltage source 307 with opposite phases and therefore reducing the AC component. Waveform 303 of FIG. 3b is one of the complementary signals at node 313 and 314. The signals at node 313 and 314 will be rectified by the circuit 303. Diode rectifier, full bridge and switched transistor rectifier can be used for this purpose. The rectifier output at node 315 drives the load 304. Waveform 303 depicts the voltage at node 314 and waveform 304 is the rectified waveform at node 315. Waveform 305 depicts the current from the voltage source 307 and waveform 306 is the current through the load 304. The simulation of FIG. 3b depicts the system during the start-up phase.

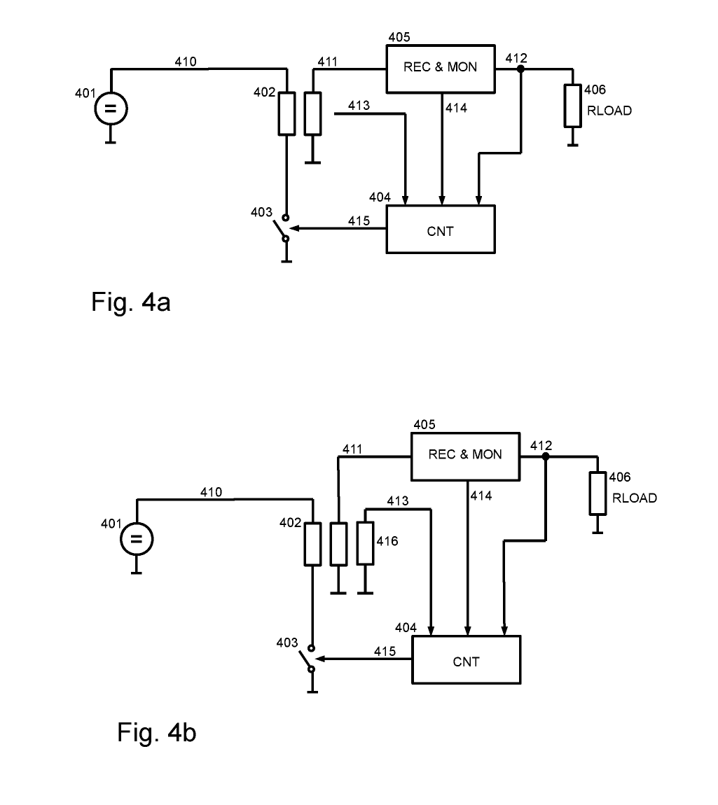

FIG. 4 depicts an embodiment of a power converter having a controller 404. Components having similar functions to those described with respect to other figures, above, are labeled with similar reference numerals, iterated by 100. This numbering system is used throughout the application. The circuit configuration of the voltage source 401, the coupled transmission line 402 and switch 403 could be any configuration of FIG. 1a, 1b or 1c. The controller 404 can monitor the status of the waves in the coupled transmission line 402, the output current in the load 406, the output voltage at node 412, the current in through the rectifier 405, voltage or power associated with the switch 403 to generate the switch control signal 415 in order to optimize for a design parameter, such as, the output voltage, the output current, the output power and/or efficiency of the circuit.

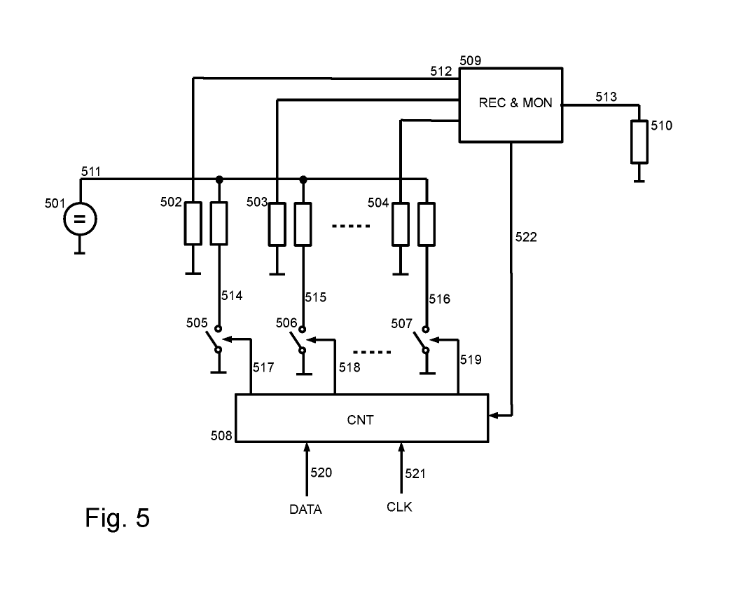

FIG. 5 depicts an embodiment of a multi-bit power converter with a controller and a digital input. Digital input signal 520 comprises data carrying the information of the expected output power of the converter. An additional clock signal 521 can be used to synchronize the output update to the clock signal. Further, the period of the clock signal can be optimized for the electrical length of the coupled transmission lines 502, 503, and 504. Based on the digital input signal 520 the controller 508 will activate the switches 505 to 507 via control signals 517 to 519 such that the output voltage at node 513 or output current through monitor 509 or the output power over load 510 is according to the digital input signal 520. With the circuit of FIG. 5 a digital to analog converter (DAC) can be designed. The odd mode and even mode impedances of the individual coupled transmission lines 502 to 504 can be different. This allows for segmentation of the DAC into most significant bits and least significant bits, like the segmentation in current steering DACs. Also, the coupled transmission lines 502 to 504 could be operated with different supply voltages to further improve the weighting of the segments. Those of ordinary skill in the art will appreciate that more or fewer coupled transmission lines 502 to 504 can be provided in embodiments. Each coupled transmission line can have associated switches and control signals as required.

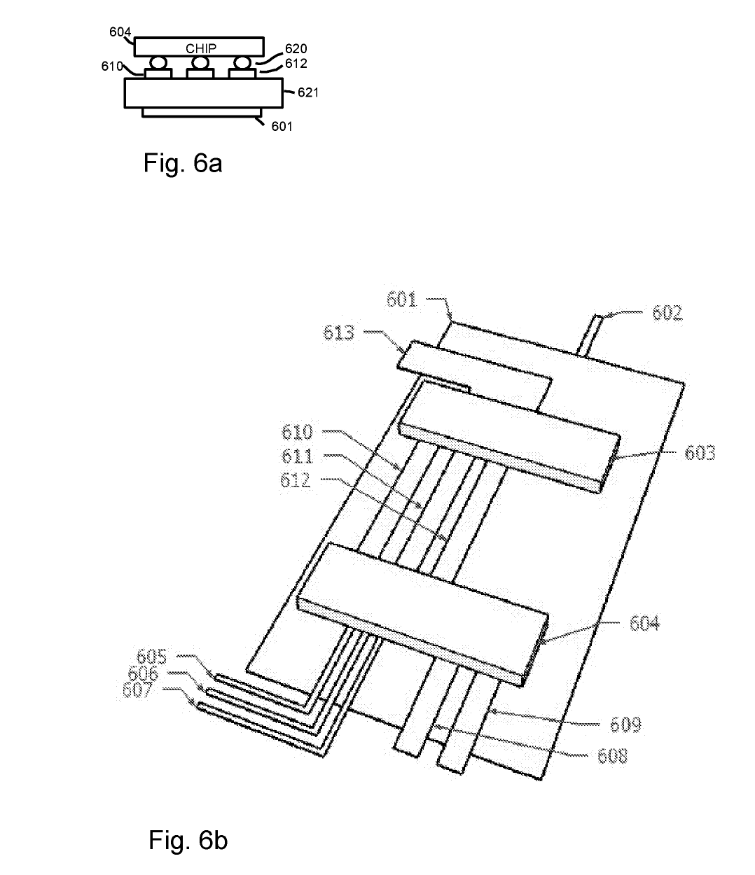

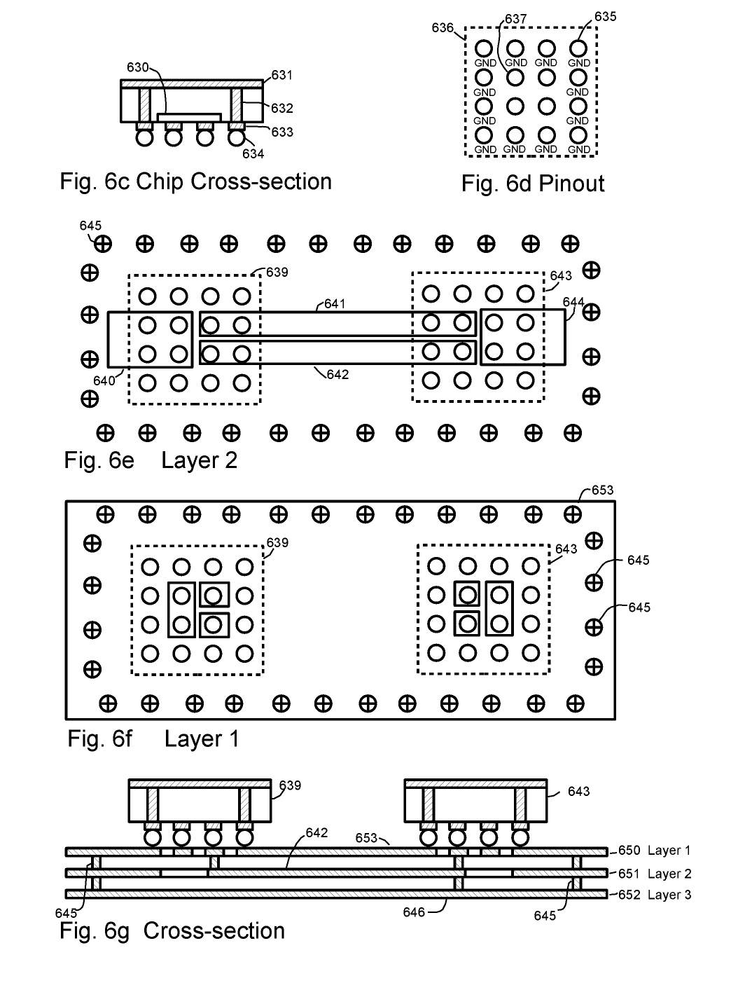

FIGS. 6a and 6b depict a physical embodiment of a multi-bit power converter. FIG. 6a is a cross-section of a printed circuit board consisting of a dielectric 621, a top layer with coupled transmission lines 610, 611, and 612 and a bottom layer 601 function as ground plane. In one example, transmission lines 610 and 612 could couple to a common transmission line 611. Transmission lines 610 to 612 and 601 form the multiple coupled transmission lines. FIG. 6b is a top view of the PCB. The switching elements and controller can be fabricated on chip 604. The rectifier and monitor can be implemented in the chip 603. Chip 603 collects an rectifies the waves generated by chip 604 and converts them into output signal 613. Lines 608 and 609 provide power to the chip 604 and lines 605, 606 and 607 carry the switch control signals to chip 604.

The disclosed circuits can operate with high current and high voltages at high frequencies. Therefore, electromagnetic compatibility (EMC) is a problem. Some EMC problems can be mitigated by implementing the circuits in a differential or complimentary fashion, another method is shielding. FIGS. 6c to 6g depict a physical embodiment of a circuit which encases itself in a ground cage. The circuit consists of two chips 639 and 643 and a pair of transmission lines 641, 642 in between the chips.

FIG. 6c depicts an embodiment of the chip construction. According to this embodiment, the chip is produced in flip chip technology wherein the connection from the chip to the laminate or printed circuit board (PCB) is made by bumps 634 and pads 633. Ground bumps 635 are arranged around the perimeter of the chip as indicated in FIG. 6d. Signal bumps 637 occupy the inner rows and columns of the chip 636. A set of through silicon vias 632 connect the ground bumps 635 to a conductive layer at the backs side of the die 631 and, hence, encapsulating the entire circuitry 630 of the chip in a conductive ground cage.

FIGS. 6e and 6f depict the first layer 650 and second layer 651 of the laminate or PCB. FIG. 6g depicts a cross-section of the laminate or PCB. In FIG. 6e the transmission lines 641 and 642 transmit the power between chip 639 and 643 via electromagnetic waves. The inner conductors of transmission lines are formed with lines 641 and 642 and the outer conductors of the transmission lines are formed by the ground plane 653 on first layer 650 and the ground plane 646 on third layer 652. Second layer 651 is cut out to hold the inner conductors of transmission lines 641 and 642. The side walls of the cut-out are part of the outer conductor of the transmission lines 641 and 642. The ground planes 653, 646 and the ground planes on layer 651 can be stitched together by multiple vias 645 as shown in FIG. 6e to 6g.

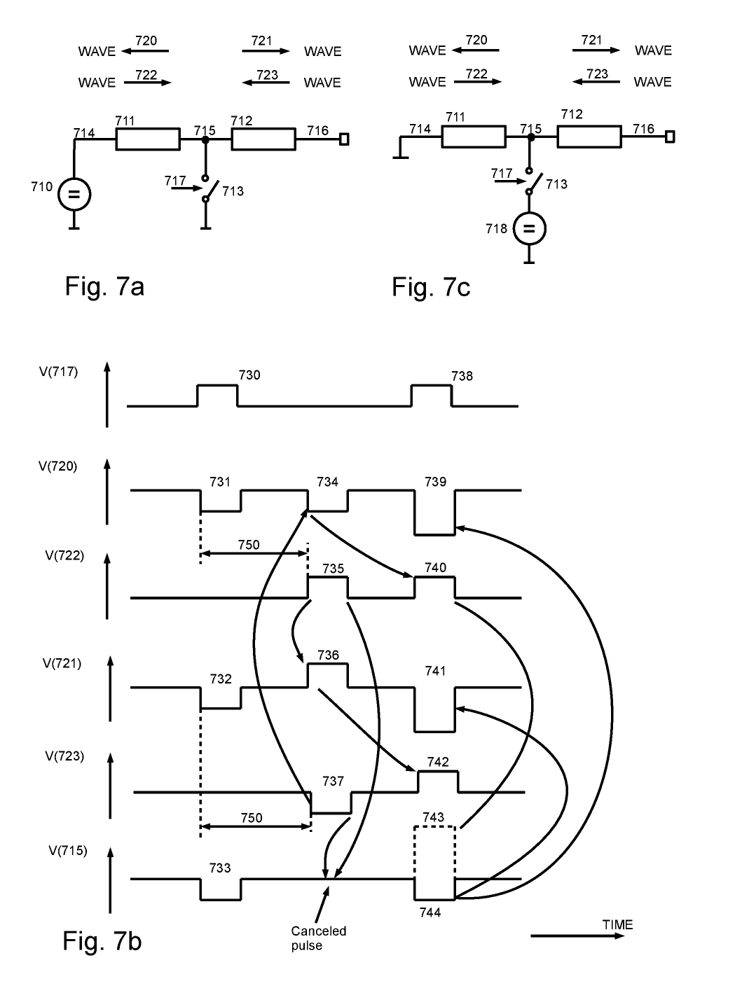

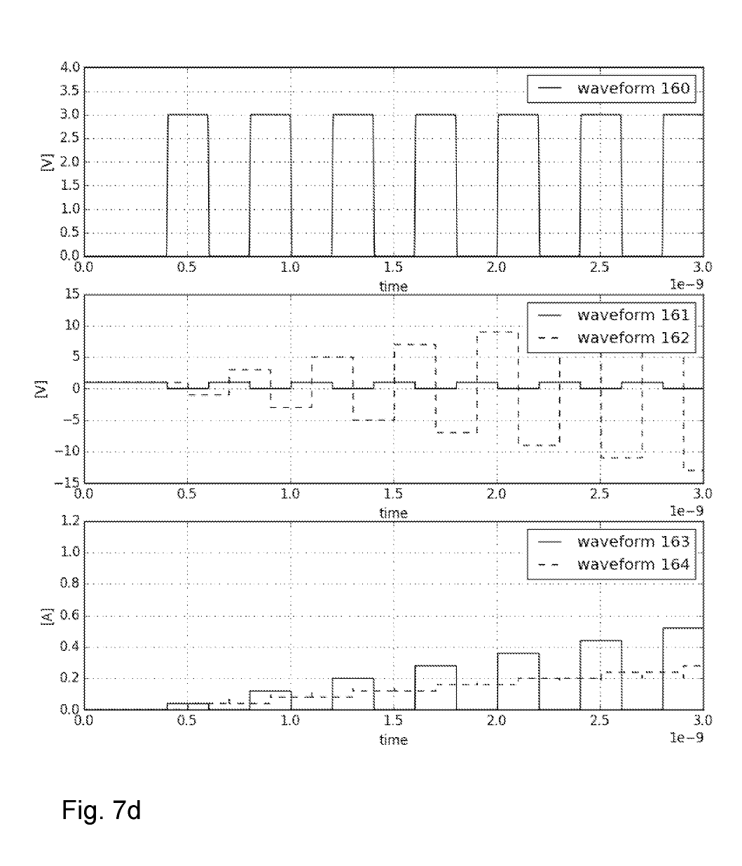

FIG. 7a depicts an embodiment of a DC to AC converter. Transmission line 711 is connected to a voltage source 710. Switch 713 can, based on input signal 717, connect node 715 to the ground node and therefore discharge transmission lines 111 and 112. The electrical length of the transmission lines 711 and 712 determines the time a pulse needs to travel from one end of the transmission line to the other end. The lengths of both transmission lines are the same. The period of the switch control signals 717 can be substantially a multiple of 4 times the electrical length of one of the transmission lines 711 and 712.

The transmission lines can be built using lumped components, coaxial cable, wave guide, strip line, micro strip line or coplanar wave guide, distributed MEMS transmission lines, lumped distributed transmission line, or digitally controlled artificial dielectric (DiCad) transmission line.

FIG. 7b depicts a startup timing diagram of the circuit of FIG. 7a. Waves 720, 721, 722, 723 in FIG. 7a depict the waves going into and coming out of the transmission lines 711 and 712. Pulse 730 on the gate of switch 713 causes the switch to change into a low impedance state. The low impedance state causes pulse 731, which travels as wave 720 into transmission line 711, and pulse 732, which travels as wave 721 in transmission line 712. The pulses 731 and 732 get reflected at the opposite ends of the transmission lines. Pulse 731 will be reflected negatively due to the reflection on the low impedance voltage source 710. Pulse 732 will be reflected positively due to the reflection on the open transmission line 712. The reflected pulse 735 and 737 will arrive at node 715 after twice the electrical length of the transmission line 711 and 712. Pulse 735 and 737 are now of opposite polarity and will cancel each other when overlapping at node 715. The voltage level after an odd number of reflections will always be limited since a positive and a negative pulses cancel each other. Therefore, during this stage of the cycle the voltage over the switch 713 is limited. The pulse 735 coming out of transmission line 711 will continue as pulse 736 in transmission line 712 and pulse 737 will continue as pulse 734 in transmission line 711. The pulse 734 and 736 will be reflected to form reflected pulse 740 and 742. Pulse 742 is the positive reflection of pulse 736 and pulse 740 is the negative reflection of pulse 734. At this time, after 2 reflections, the pulses have the same sign and would add up to pulse 743. However at the time the pulse arrive at node 715 switch 713 will be closed by gate pulse 738 and the voltage at node 715 is forced to ground. This causes pulse 740 to be reflected back into transmission line 711 mirrored around the ground node causing pulse 739. The same holds for the pulse 742 and the resulting reflected pulse 741. The amplitudes of pulses 739 and 741 are now higher by the voltage of voltage source 710. The voltage of the pulses are increasing by the voltage of the voltage source 710 at every cycle. Due to the reflections at the open transmission line 712, the voltage at the output node 716 is two times the voltage of pulse in the wave 721. With increasing pulse voltage the pulse current will increase too. One limit for the maximum voltage at the output node 716 is the on resistance of the switch 713. The on resistance limits the amount of energy that can be added to the system at every cycle.

FIG. 7c depicts an embodiment of a DC to AC converter. The circuit of FIG. 7c is similar to the circuit in FIG. 7a. But instead of discharging the transmission lines 711 and 712 via switch 713 the transmission lines 711 and 712 are charged via switch 713 to the voltage of voltage source 718. The circuit of FIG. 7c can be used to build a step down converter by adding a supply voltage regulator between node 714 and ground. A simplified analysis of the relationship between the output voltage to the load resistance (r1) at node 716, the characteristic impedance (z0) of transmission lines 711 and 712 and the voltage of voltage source 718 can be conducted by following one of the two pulses generated by closing switch 713 to the voltage source 718 and following the pulse through the network. Let Vr0 be the pulse traveling as wave 720 in transmission line 711. The pulse is reflected at node 714 with a reflection coefficient of −1. The pulse will travel to node 716 while the switch 713 is open. At node 716 the pulse will be reflected back with a reflection coefficient of g=(z0−r1)/(z0+r1). At the time the pulse reaches node 715 the switch 713 will be closed. Therefore, the pulse will be reflected back to node 716. The pulse amplitude, at this time, is Vr1=g*Vs+Vs. Meanwhile the pulse traveling as wave 721 in transmission line 712 will be reflected at node 716 with reflection coefficient g and will travel to node 714. At node 714 it will be reflected with reflection coefficient −1. When the pulse comes back to node 715 the switch 713 will be closed and the pulse will be reflected towards node 714 having now an amplitude of Vl1=g*Vs+Vs. At this time the pulses Vr1 and Vl1 will have the same amplitude. After the second cycle the pulses will have an amplitude of V2=g*(g*Vs+Vs)+Vs. After the third cycle the pulses will have an amplitude of g*(g*(g*Vs+Vs)+Vs)+Vs. This is a geometric series with its limit converging to Vs/(1−g). The output voltage at node 716 is (1+g)*Vn where vn is the voltage of the pulse traveling towards node 721 in the nth cycle. Substituting z0 and r1 and the limit yields to a first order formula for the output voltage at node 716 given by: vout=r1/z0*vs.

FIG. 7d depicts the simulation results of the circuit in FIG. 7a. In this embodiment, the voltage of voltage source 710 is 1V. The characteristic impedance of transmission lines 711 and 712 is 50 Ohm. Waveform 160 is the input signal 717 and the period of the input signal 717 is 400 picoseconds. Waveform 161 is the voltage at node 715 and waveform 162 is the voltage at node 716. Waveform 163 depicts the current drawn from voltage source 710 and waveform 164 depicts the current through switch 713.

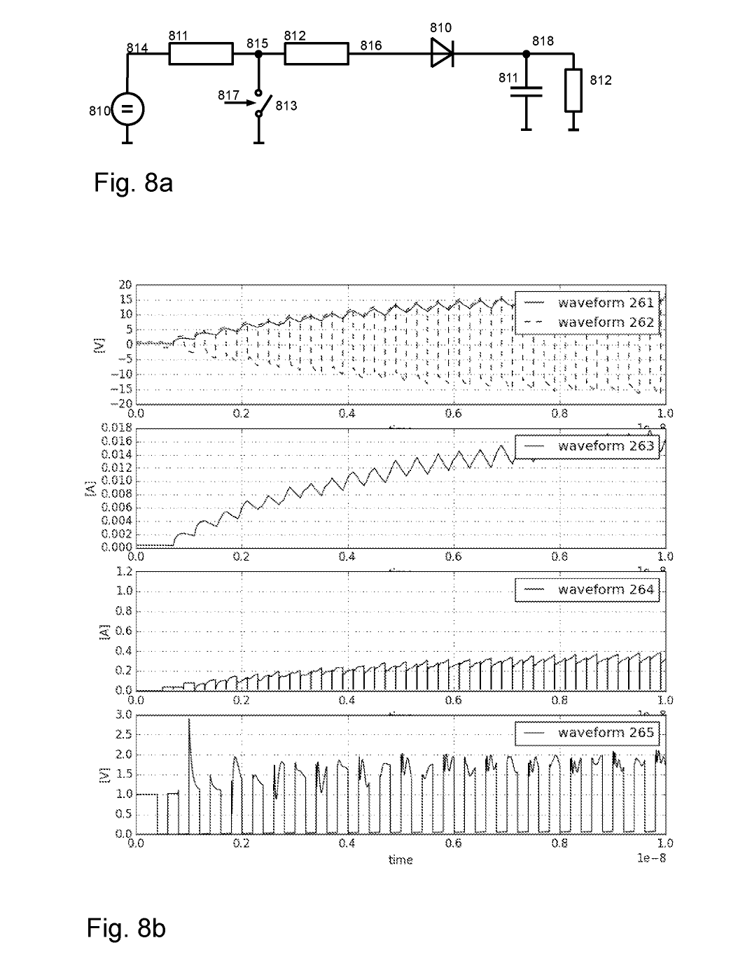

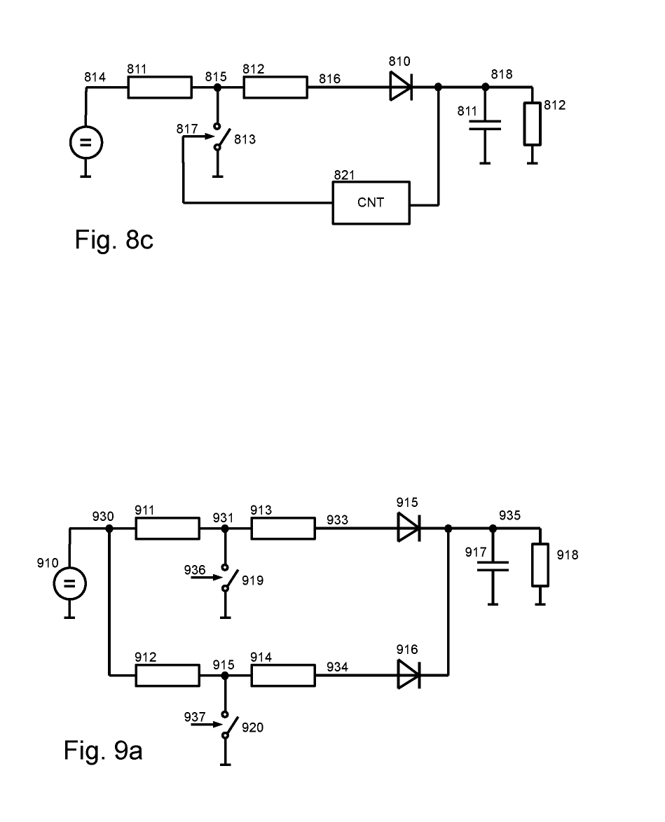

FIG. 8a depicts an embodiment of a DC to DC converter. The circuit operates the in a similar manner to the circuit of FIG. 7a. At the output node 816 a rectifier consisting of diode 810 and capacitor 811 are added to convert the AC voltage of node 816 to a DC voltage on node 818.

FIG. 8b depicts simulation results of the circuit in FIG. 8a. Waveform 261 is the rectified output voltage at node 818 over the load resistor 812 and waveform 262 is the AC voltage on node 816. Waveform 263 is the output current through load resistor 812. Waveform 264 is the current drawn from the voltage source 810. Waveform 265 is the voltage at node 815. Contrary to the circuit in FIG. 7a, the pulses going towards node 816 aren't fully reflected back to node 815. Some of the pulse energy is delivered to the load 812. The reflected pulse is smaller and won't compensate completely for the pulse coming from node 814 at node 815. Therefore the voltage at node 815 will be higher and result in more voltage stress over switch 813 during the off cycle. The voltage on node 813 will settle as the energy taken out of the circuit over the load resistor equals the energy dumped into the circuit by discharging the transmission lines.

FIG. 8c depicts an embodiment of a DC to DC converter in which a controller 821 is used to control the output voltage on node 818. The controller compares the output voltage to a reference voltage. If the output voltage 818 is higher than the reference voltage the controller stops sending trigger pulses 817 to the switch 813 and therefore preventing switch 813 to add energy to the pulse in the transmission lines 811 and 812. The load 812 will discharge node 818 till the output voltage is smaller than the reference voltage at which point the controller 821 will start sending trigger pulses to switch 813 again.

Not triggering switch 813 while the reflected pulses will overlap on node 815 will cause voltage stress on the switch 813. To avoid this, a second switch can be added between node 815 and a voltage source equal to the voltage source at node 814. The second switch can be triggered in case switch 813 is not triggered. Connecting node 815 will cause the desired reflection at node 815 but will not add additional energy into the transmission lines.

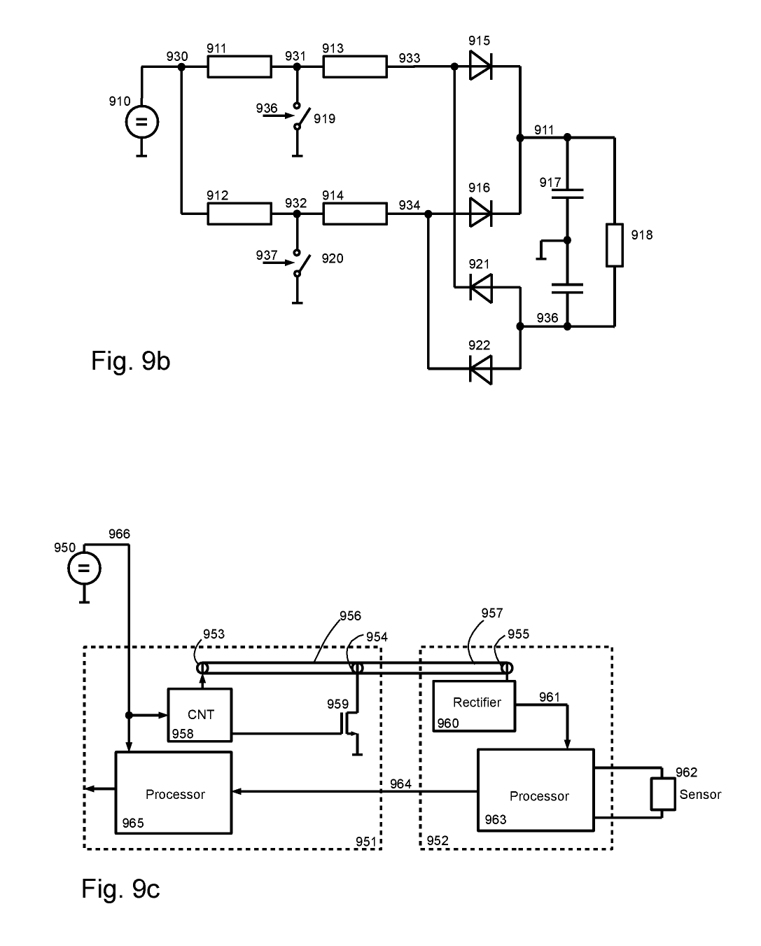

FIG. 9a depicts an embodiment of a DC-DC converter wherein a continuous current is supplied to the load. The circuits in FIG. 7 and FIG. 8a deliver current during half the cycle to the load. The circuit of FIG. 9a consists of two circuits of FIG. 8a operating in parallel. The control signals 936 and 937 are complementary. The switches 919 and 920 are therefore operating 180 degrees out of phase. This results in a positive voltage at node 933 while the voltage on node 934 is negative and vice versa. When the current through diode 915 will stop, due to a negative voltage at node 933, the voltage on node 934 will be positive and force a current through diode 916 towards the load 918.

FIG. 9b depicts an embodiment of a DC-DC converter wherein a continuous current is supplied to the load. The negative voltage cycles of the waveform at node 933 and 934 are used to produce a negative voltage at node 936 relative to ground. As with the circuit of FIG. 9a the transmission lines 911 and 912 can be coupled and transmission lines 913 and 914 can be coupled.

FIG. 9c depicts an embodiment of a DC-DC converter wherein the rectifier 960 and the switch 959 are integrated in two different chips. A two chip arrangement as shown in FIG. 9c is common in analog front ends, wherein a digital signal processing chip 951 is fabricated in a first process technology and an analog signal processing chip 952 is fabricated in a second process technology. The first process technology requires a first power supply voltage and the second process requires a second power supply voltage different from the first power supply voltage. To simplify the system only one power supply 950 is provided. The DC-DC converter of FIG. 8 can be used to generate the supply voltage 961 for the second chip 952. Further, the DC-DC converter can be integrated in the two chips. The switch controller 958 an the switch 959 can be implemented on the first chip 951 and the rectifier 960 can be implemented on the second chip. The transmission lines 956 and 957 can be implemented on the PCB or laminate on which the chips 951 and 952 are mounted. In FIG. 9c the connections to the transmission lines 956 and 957 are made via bump connections 953, 954 and 955. The energy transport from the chip 951 to chip 952 is carried out over a standing wave on transmission line 957. This configuration reduces the external component count of the system and therefore reduces cost. Also, in case of a step-up conversion, the switch 959 in the first chip 951 can be produced with low voltage transistors and still generate high voltages at the second chip 952. This is due to the pulse-canceling effect when the switch 959 is in a high impedance state.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A power conversion circuit comprising:
an electric power source having a first terminal and a second terminal;
a switching element;
an output terminal;
a first termination element;
a second termination element;
a first wave propagation medium having a first and a second terminal;
a second wave propagation medium having a first and a second terminal;
wherein the switching element is coupled between the first terminal of the first wave propagation medium and the first terminal of the electric power source and the first termination element coupled to the second terminal of the first wave propagation medium and the second terminal of the second wave propagation medium is coupled to the output terminal and the second termination element is coupled to the first terminal of the second wave propagation medium;
a forward traveling, from the first terminal to the second terminal, wave in the first wave propagating medium;
a backward traveling, from the second terminal to the first terminal, wave in the first wave propagating medium;
wherein the forward traveling wave and the backward traveling wave form a standing wave in the first wave propagation medium and the switching element adjusts the reflection coefficient at the first terminal of the first wave propagation medium and injects energy into the first wave propagation medium to sustain the standing wave.

2. The power conversion circuit according to claim 1,
wherein the first wave propagation medium is electromagnetically coupled to the second wave propagation medium.

3. The power conversion circuit according to claim 1,
wherein the first terminal of the first wave propagation medium is coupled to the first terminal of the second wave propagation medium.

4. The power conversion circuit according to claim 3,
wherein the second terminal of the electric power source is coupled to the second terminal of the first wave propagation medium.

5. The power conversion circuit according to claim 1, further comprising:
a load; and
a rectifier;
wherein a rectifier is connected between the output terminal and the load.

6. The power conversion circuit according to claim 1, further comprising
a load, the load connected to the output terminal; and
a controller;
wherein the controller monitors at least one of the power, current and voltage at the load and controls the switching element.

7. The power conversion circuit according to claim 1 further comprising:
one or more second switching element;
one or more second output terminal;
one or more third termination element;
one or more fourth termination element;
one or more third wave propagation media having a first and a second terminal;
one or more fourth wave propagation media having a first and a second terminal;
wherein the first terminals of the one or more third wave propagation media are each coupled to the one or more second switching elements,
and the second terminals of the one or more third wave propagation media are each coupled to the one or more third termination elements,
and the first terminals of the one or more fourth wave propagation media are each coupled to the one or more fourth termination elements,
and the second terminals of the one or more fourth wave propagation media are each coupled to the one or more second output terminals.

8. The power conversion circuit according to claim 7 further comprising,
a multiple input rectifier having multiple inputs and an output;
a load terminal;
wherein the multiple inputs are coupled to the output terminal and to the one or more second output terminals and the output is connected to the load terminal.

9. A power conversion circuit according to claim 1,
wherein the electric length of the wave propagation devices is substantially a integer multiple of one fourth of the period of the standing wave.

10. A power conversion circuit according to claim 1,
wherein the first and second wave propagation medium is implemented on a PCB or laminate and the switching element is implemented on a first chip and the output terminal is implemented on a second chip and the first wave propagation medium is between the first and the second chip.

11. A method for power conversion comprising:
generating an electromagnetic standing wave by injecting energy in a resonant first wave propagation medium;
coupling all or part of the energy flowing in the first wave propagation medium into a second wave propagation medium and generating a standing wave in the second wave propagation medium;
extracting out all or part of the energy in the second wave propagation medium and delivering the extracted energy to a load.

12. The method of claim 11 further comprising:
rectifying the extracted energy and delivering the rectified output energy to the load.

13. The method of claim 11 further comprising:
monitoring the energy delivered to load and controlling the energy injected in the first wave propagation medium based on the monitored energy.

14. The method of claim 11 further comprising:
generating a plurality of electro-magnetic standing wave by injecting energy in a plurality of resonant first wave propagation device;
coupling all or part of the energies flowing in the pluralities of first wave propagation device into a plurality of second wave propagation device and generating a plurality of standing wave in the plurality of second wave propagation medium;
extracting all or part of the pluralities of energies in the plurality of second wave propagation medium combining the plurality of energies; and
delivering the combined pluralities of energies to a load.

15. The method of claim 11, wherein the method is used for:
DC/DC conversion;
AC/DC conversion;
DC/AC conversion;
radio transmission with carrier wave generation and mixing; or
modulated amplification.

16. A power conversion circuit comprising:
an electric power source having a first terminal and a second terminal;
a switching element, adapted to receive a control signal;
an output terminal;
a first termination element;
a second termination element;
a first wave propagation medium having a first and a second terminal;
a second wave propagation medium having a first and a second terminal;
wherein the switching element is coupled between the first terminal of the first wave propagation medium and the first terminal of the electric power source and the first termination element coupled to the second terminal of the first wave propagation medium and the second terminal of the second wave propagation medium is coupled to the output terminal and the second termination element is coupled to the first terminal of the second wave propagation medium;
wherein the control signal controls the switching element such that a forward traveling, from the first terminal to the second terminal, wave is created in the first wave propagating medium and a backward traveling, from the second terminal to the first terminal, wave is created in the first wave propagating medium;
wherein the forward traveling wave and the backward traveling wave form a standing wave in the first wave propagation medium and the control element controls the switching element to adjust the reflection coefficient at the first terminal of the first wave propagation medium and inject energy into the first wave propagation medium to sustain the standing wave.
